(19) United States
(12) Patent Application Publication
(10) Pub. No.: US 2008/0101878 A1
(43) Pub. Date: May 1, 2008

(54) TOOL FOR CUTTING MACHINING

(75) Inventor: Bengt Skilberg, Skinnskatteberg (SE)

Correspondence Address: WRB-IP LLP, 1217 KING STREET, ALEXANDRIA, VA, 22314, US

(73) Assignee: SECO TOOLS AB, Fagersta (SE)

(21) Appl. No.: 11/924,638

(22) Filed: Oct. 26, 2007

(30) Foreign Application Priority Data
Oct. 26, 2006 (SE) 0602263-6

(51) Int. Cl. B26D 1/12

(52) U.S. Cl. 407/54

(57) ABSTRACT

A cutting portion for rotary cutting machining includes a cutting edge structure which comprises at least one cutting edge which is integral with the cutting portion. The cutting portion includes a fastening structure for mounting of the cutting portion to the holder. The cutting portion includes a gripping structure for a wrench that shall be used for mounting the cutting portion to the holder. The cutting portion includes an intermediate, substantially round, part provided between the first fastening structure and the cutting edge structure. The intermediate part includes at least one friction surface provided with one or more recesses or one or more protrusions intended to cooperate with a wrench. The recess or protrusion has a component extending substantially radially.

### BACKGROUND AND SUMMARY

The present invention relates generally to a cutting portion in a tool for rotary cutting machining and a wrench that shall be used for mounting the cutting portion to a holder of the tool.

It is previously known through applicant's WO2006/033617 to provide a solution to the problem of providing milling and drilling tools in small dimensions having interchangeable cutting edges. However, it has shown in some cases at cutting portion exchange that the cemented carbide in the cutting portion is broken at the wrench grip at tightening. In addition, the gap of the wrench has been widened by great torque such that also the wrench has been damaged.

It is desirable to provide a cutting portion, which has a great strength.

It is desirable to provide a cutting portion, which allows simplified tightening and loosening.

It is desirable to provide a wrench, which makes simplified tightening and loosening possible.

According to an aspect of the present invention, a cutting portion is provided with a cutting edge structure, the cutting portion being adapted to be a part of a tool, the tool comprising the cutting portion and a holder, the cutting portion comprising the cutting edge structure having at least one cutting edge integral with the cutting portion, the cutting portion comprising a fastening structure for mounting of the cutting portion to the holder, the cutting portion comprising a gripping structure for a wrench to be used for mounting the cutting portion to the holder, wherein the cutting portion is made of cemented carbide and comprises an intermediate, substantially round, part provided between the first fastening structure and the cutting edge structure, and the intermediate part comprises at least one friction surface provided with at least one of a recess and a protrusion adapted to cooperate with the wrench, the at least one of the recess and the protrusion having a component extending substantially radially.

### BRIEF DESCRIPTION OF THE DRAWINGS

The invention will be described below with reference to the enclosed drawings, wherein

FIG. 1A shows a side view of a cutting portion according to an aspect of the present invention mounted to a holder in cross-section, and a wrench according to an aspect of the present invention;

FIG. 1B shows a cross-section according to the line 1B-1B in FIG. 1A;

FIG. 1C shows a magnified cross-section of the cutting portion according to FIG. 1B;

FIG. 1D shows a magnified cross-section of an alternative cutting portion;

FIG. 2 shows a perspective view of the cutting portion in FIG. 1A;

FIG. 3 shows a perspective view of the cutting portion and wrench in FIG. 1A in tightening position;

FIG. 4A shows a plan view of the wrench according to an aspect of the present invention; and

FIG. 4B shows a perspective view of the wrench according to an aspect of the present invention.

### DETAILED DESCRIPTION

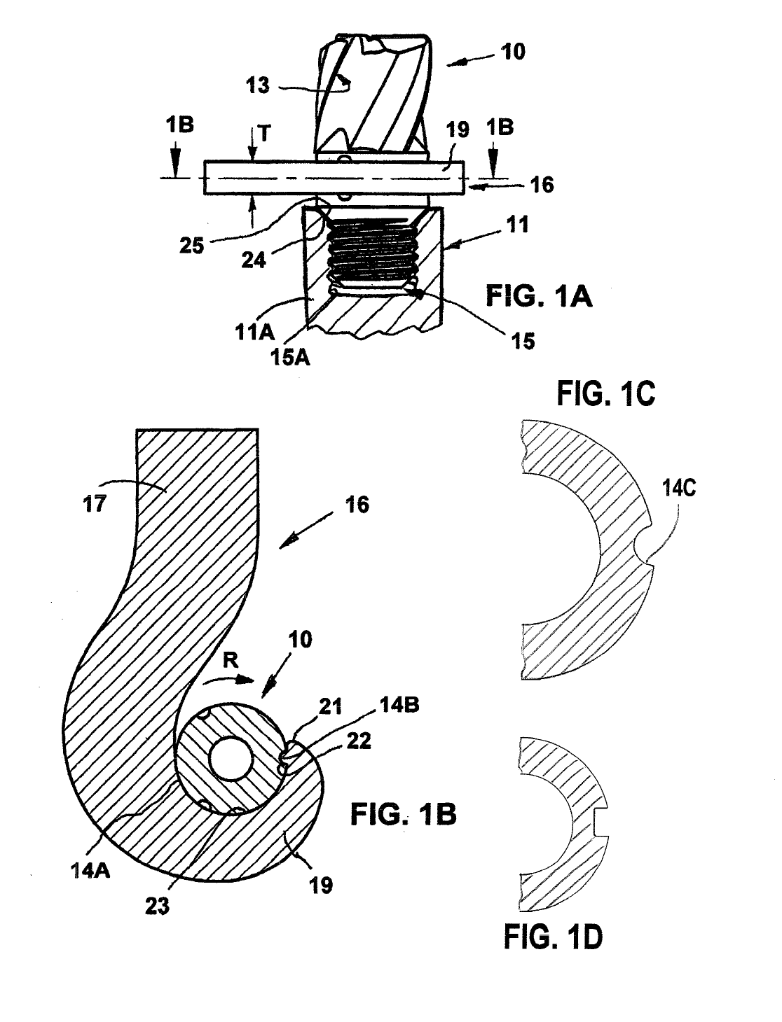

The tool shown in FIG. 1 comprises a cutting portion 10 according to an aspect of the present invention, and a holder 11. The cutting portion 10 is adapted to be interchangeably mounted in the holder 11 by means of a fixed wrench 16.

The cutting portion can be an exchangeable tool such as a cutting tool that is made of a hard material such as cemented carbide, although the holder may be a more easily machined material, such as steel. By “cemented carbide” is here meant WC, TiC, TaC, NbC, etc. in sintered combination with a binder metal such as for example Co or Ni. The cutting portion may be pressed and sintered with subsequent machining or injection molded and possibly machined, such as ground. The cutting portion 10 comprises a first fastening structure 12 and a cutting edge structure 13, which is integral with the cutting portion, i.e. is performed in the same material as the cutting portion. The cutting portion 10 comprises an intermediate, substantially round, part 14 provided between the first fastening structure 12 and the cutting edge structure 13. The first fastening structure 12 comprises in the shown embodiment a cylindrical male thread 12A. Alternatively, the first fastening structure can be a female thread or a part of a bayonet coupling. In addition, conical threads can be used in stead of cylindrical threads.

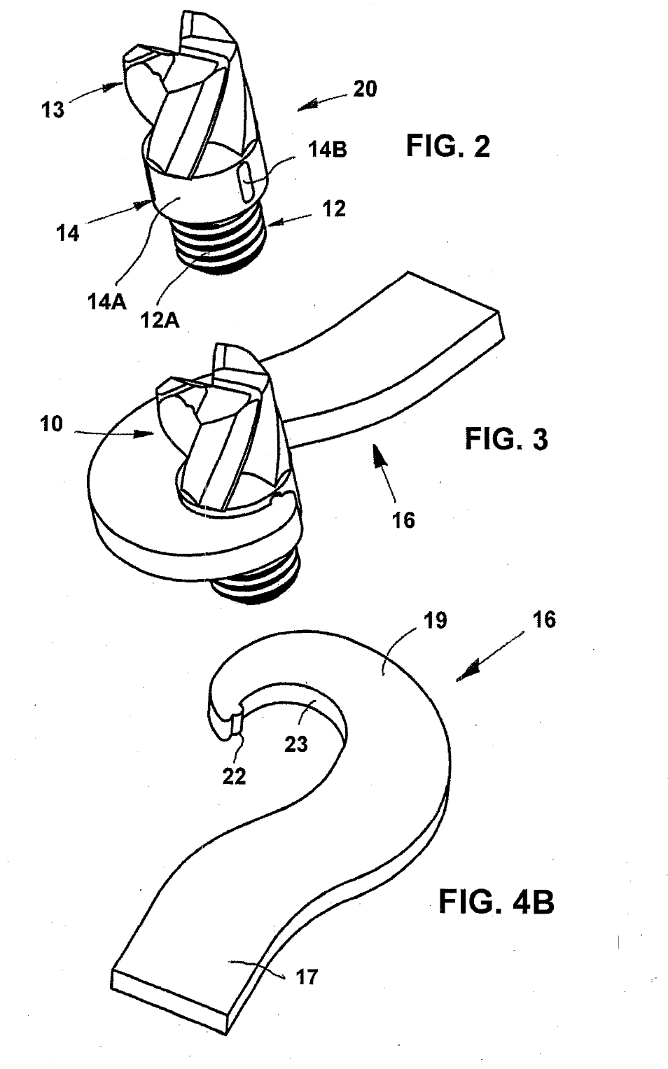

The cutting edge structure 13 comprises at least one cutting edge, which is given different design depending of application. A preferred shape of the forward end of the cutting portion 10 is shown in detail in FIG. 1A and FIG. 2. The cutting edge structure comprises three, helical, main cutting edges. The number of main cutting edges may alternatively be one, two or four to six. Each main cutting edge is formed along the intersection line of a clearance surface and a chip flute. The main cutting edge lies in the envelope surface on a common, imaginary cylinder, which is concentric with the rotational axis of the cutting portion and the tool. The minor cutting edges are formed at the intersection of the chip flute and a surface facing away from the fastening structure and have substantially radial extensions inwardly from the imaginary cylinder, whereof at least one minor cutting edge substantially connects to or intersects the axis of rotation of the cutting portion for the tool to be able to drill inwards into a work piece during milling. The intermediate part 14 may include a cylindrical friction surface or jacket surface 14A provided with a plurality of recesses 14B. This can be expressed like, the cutting portion comprising gripping structure 14A, 14B for a wrench that shall be used for mounting the cutting portion to and dismounting the cutting portion from the holder. The number of illustrated recesses 14B is three, but it may alternatively be selected within the interval of 1-10 pieces. The recesses are preferably evenly distributed along the jacket surface 14A, i.e. they are provided at 120° partition in the shown example. Each recess 14B may have a cross-section similar to a part of a cylinder and has ends, in axial direction, which are rounded. The axial length of the recess may be shorter than the axial length of the fastening structure. The recess may have other forms than the one shown. For example its basic shape can be part spherical, rectangular (as illustrated in FIG. 1D), square, etc. Each recess may alternatively be made from smaller recesses, separate from each other. It is also conceivable that projections are used in stead of recesses even if the likes are more easily shorn at tightening. The recess or protrusion has a component 14C (as illustrated in FIG. 1C) extending substantially radially relative to the rotational axis of the cutting portion for cooperation with the protrusion 22 and a recess, respectively, of the wrench. The cutting portion may be provided with a first conical part 24, which connects to the fastening structure 12 and to the intermediate part 14.

The holder 11 preferably comprises a cylindrical body 11A. The axially forward end of the holder is provided with a second fastening structure 15. The second fastening structure 15 comprises in the shown embodiment a cylindrical female thread 15A provided in a cavity in the holder. Alternatively, the first fastening structure can consist of a male thread or any part of a bayonet coupling. The holder may be provided with a second conical part 25, which connects to the fastening structure 12 and to the free end of the holder.

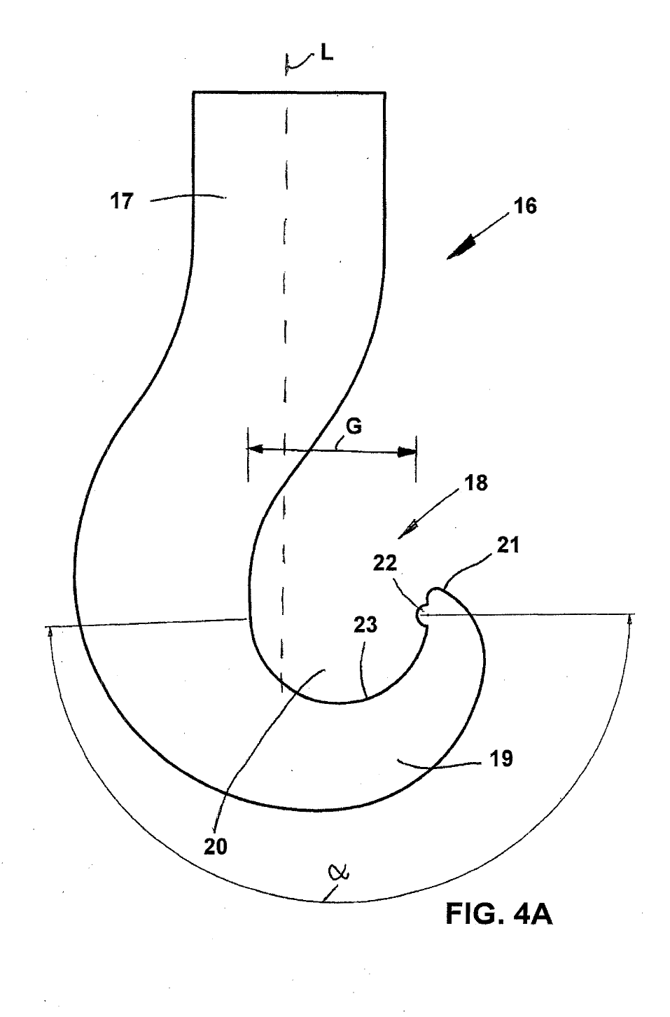

The wrench 16 is shaped to have only one usable rotational direction R for each engagement with the cutting portion. The wrench has a shank 17 and a head 18. The shank is preferably straight and may be longer than in the shown embodiment. The shank has a mid line L. The head 18 is curved and extends on both sides of the mid line L such that the head forms a hook 19 on the shank, such as is illustrated in FIGS. 4A and 4B. An inner space 20 is formed thereby, partly enclosed by the hook. The hook 19 ends in a blunt tip 21. The hook 19 may be more elastic closer to the tip 21 than in the vicinity of the shank, i.e. there may be a smaller amount of material, for example steel, in said area than closer to the shank. A protrusion or a barb 22 is formed in the wrench adjacent to the tip 21. The protrusion is facing towards the space 20. The protrusion 22 defines a gap G of the wrench with an opposite surface of the space, see FIG. 4A. The gap is preferably smaller than the diameter of the portion 14. Each protrusion 22 may have a cross-section similar to a part of a cylinder. The axial length of the protrusion may be equal to the thickness T of the wrench, see FIG. 1A. The axial length of the protrusion 22 is preferably shorter than the axial length of the recess 14B. The protrusion may have other forms than the one shown. Its basic shape may for example be part spherical, rectangular, square, etc. Each protrusion may alternatively consist of from each other separate smaller protrusions. The wrench may be rigid. Elasticity is not needed for the wrench to grip on the cutting portion since there is sufficient space to turn/push the wrench to the cutting portion. It is also conceivable that recesses are used in stead of protrusions. An inner clamping surface 23 connects to the protrusion 22. The clamping surface 23 extends on both sides of the mid line L and encloses an angle α that is less than or equal to 180°, measured from the innermost point or line of the protrusion 22, see FIG. 4A. The clamping surface 23 is preferably defined by a radius that is of the same magnitude as a radius defining the friction surface 14A.

Mounting of the cutting portion to the holder can be done in the following manner. The fastening structure 12 of the cutting portion is put against the cavity of the holder and is rotated, preferably by hand, such that the threads 12A and 15A comes in engagement with each other. Rotation of the cutting portion may continue until the conical parties 24 and 25 lightly abut against each other. The wrench 16 may thereafter be brought from for example the side against the intermediate part 14, see FIG. 3 such that the clamping surface 23 abuts against the jacket surface 14A of the cutting portion. Thereafter the wrench 16 is rotated relative to the cutting portion until one of the protrusions 22 enters one of the recesses 14B. Rotation of the wrench 16 relative to the cutting portion 14 is thereby stopped such that the wrench brings the cutting portion. Alternatively, the protrusion 22 may be allowed to enter the recess 14B before the clamping surface 23 abuts against the jacket surface 14A of the cutting portion. Torque is created in the wrench since the conical parties 24 and 25 counteracts further tightening, whereby the clamping surface 23 comes into frictional engagement with the intermediate part 14. The frictional engagement will then have an extension under an angle that is greater than 10°, preferably greater than 90°, but smaller than 180°. The cutting portion can thereby be drawn into the holder somewhat further such that the cutting portion becomes fixed in the holder, i.e. the position according to FIG. 1A has been obtained. The cutting portion 10 is now secured in the holder 11 in a satisfactory manner. The threads in the shown embodiment are right-handed, and therefore the wrench is turned clockwise in the position according to FIG. 1B. The cutting portion is tightened in the opposite, anti-clockwise direction in case the threads are left-handed. However, the clamping surface 23 is always provided in front of the protrusion 22 in the wrench's rotational direction R.

At dismounting of the cutting portion the wrench is indexed 180°, such that the major part of the wrench is located on the right side of the cutting portion in FIG. 1B. Thereafter, the wrench is turned such that the clamping surface 23 leads before the protrusion 22 in the wrench's rotational direction and the cutting portion can be untightened.

The tool may include an axial channel, which extends through the cutting portion and the holder. The function of the channel is to supply flush medium to the cutting edges to cool these and to flush away chips.

The threads are provided as right-hand threads in right-hand cutting tools and as left-hand threads in left-hand cutting tools.

Milling cutters of small cutting portion diameters, for example 5-20 mm, should be the dominating application area for aspects of the present invention. Also drilling tools of same order of magnitude are included in aspects of the invention.

Thus an aspect of the present invention aims to provide a cutting portion, which has high strength and which allows simplified tightening and loosening. In addition, an aspect of the present invention aims to provide a wrench, which allows simplified tightening and loosening without widening the wrench's gap.

The present application claims priority to SE 0602263-6, filed Oct. 6, 2006, which is incorporated by reference.

The invention is in no manner limited to the above-described embodiments but may be freely varied within the scope of the appended claims.

1. Cutting portion provided with a cutting edge structure, the cutting portion being adapted to be a part of a tool, the tool comprising the cutting portion and a holder, the cutting portion comprising the cutting edge structure having at least one cutting edge integral with the cutting portion, the cutting portion comprising a fastening structure for mounting of the cutting portion to the holder, the cutting portion comprising a gripping structure for a wrench to be used for mounting the cutting portion to the holder, wherein the cutting portion is made of cemented carbide and comprises an intermediate, substantially round, part provided between the first fastening structure and the cutting edge structure, and the intermediate part comprises at least one friction surface provided with at least one of a recess and a protrusion adapted to cooperate with the wrench, the at least one of the recess and the protrusion having a component extending substantially radially.

2. The cutting portion according to claim 1, wherein the intermediate part comprises 1 to 10 recesses or protrusions.

3. The cutting portion according to claim 2, wherein the recesses or protrusions are evenly distributed along the friction surface, and the intermediate part is cylindrical.

4. The cutting portion according to claim 3, wherein the recesses or protrusions have a cross-section of a part of a cylinder.

5. The cutting portion according to claim 4, wherein the cutting portion is provided with a first conical part, which connects to the fastening structure and to the intermediate part.

6. The cutting portion according to claim 5, wherein the first fastening structure comprises one of a male thread, a female thread, and part of a bayonet coupling.

7. The cutting portion according to claim 6, wherein the cutting portion comprises one to six helical main cutting edges, each main cutting edge being formed along an intersection line of a clearance surface and a chip flute.

8. The cutting portion according to claim 7, wherein the main cutting edges are provided in a common, imaginary cylinder, which is concentric with an axis of rotation of the cutting portion.

9. The cutting portion according to claim 8, wherein the cutting portion comprises an axial channel that extends through the cutting portion to supply flush medium to the cutting edges.

10. The cutting portion according to claim 1, wherein the recesses or protrusions are evenly distributed along the friction surface, and the intermediate part is cylindrical.

11. The cutting portion according to claim 1, wherein the recesses or protrusions have a cross-section of a part of a cylinder.

12. The cutting portion according to claim 1, wherein the cutting portion is provided with a first conical part, which connects to the fastening structure and to the intermediate part.

13. The cutting portion according to claim 1, wherein the first fastening structure comprises one of a male thread, a female thread, and part of a bayonet coupling.

14. The cutting portion according to claim 1, wherein the cutting portion comprises one to six helical main cutting edges, each main cutting edge being formed along an intersection line of a clearance surface and a chip flute.

15. The cutting portion according to claim 1, wherein the main cutting edges are provided in a common, imaginary cylinder, which is concentric with an axis of rotation of the cutting portion.

16. The cutting portion according to claim 1, wherein the cutting portion comprises an axial channel that extends through the cutting portion to supply flush medium to the cutting edges.

17. The cutting portion according to claim 1, wherein the tool is a tool for rotary cutting machining.
